(19) United States
(12) Patent Application Publication
(10) Pub. No.: US 2004/0059434 A1
(43) Pub. Date: Mar. 25, 2004

(54) Device for automating and/or controlling machine tools or production machines

(75) Inventor: Jurgen-Andreas Reimann, Herzogenaurach (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/650,329

(22) Filed: Aug. 28, 2003

(30) Foreign Application Priority Data
Sep. 20, 2002 (DE) 102 43 771.8

(51) Int. Cl. G05B 15/00

(52) U.S. Cl. 700/1

(57) ABSTRACT

A device for automating and/or controlling machine tools or production machines is disclosed. At least one computer is located remote from a machine and connected via at least one bus system with each of the other machines for unidirectional or bidirectional exchange of data and control signals. All control functions of the machine can be integrated in the at least one remote computer. This arrangement greatly simplifies the automation and/or control of machine tools or production machines.

### CROSS-REFERENCES TO RELATED APPLICATIONS

This application claims the priority of German Patent Application, Serial No. 102 43 771.8, filed Sep. 20, 2002, pursuant to 35 U.S.C. 119(a)-(d), the disclosure of which is incorporated herein by reference.

### BACKGROUND OF THE INVENTION

The present invention relates to a device for automating and/or controlling machine tools or production machines, and more particularly to a device with at least one computer that is located remotely from an automated or controlled machine tool or production machine.

Direct data exchange between machine tools or production machines, which can also include robots, and a master computer has been steadily improved over time. More and more intelligence, combined with enhanced automation and control, have been incorporated in the machines to increase their productivity. Increasingly, decentralized systems have replaced the conventional central systems, whereby the automation and control system of each machine communicates via bus systems with the different components of the machine. Increased use of communication devices which connect the machines with each other and with a master control system also increases productivity.

A device of the aforedescribed type is described, for example, in the “NC/CNC Handbook”, Hans B. Kief, 1995/96, Karl Hansa Verlag, Munich, Vienna, page 416ff. The term DNC refers to an operating mode wherein several NC/CNC machines and/or production machines are connected to a common central computer. With conventional DNC, the control functions of an individual machine are computed entirely on the internal hardware of this machine. DNC is based on the concept that a core control element remains in each machine, with the central computer preparing or processing the data for the core control.

It would therefore be desirable and advantageous to provide an improved device for controlling a plurality of machines, in particular machine tools, processing machines and robots, which obviates prior art shortcomings and is able to specifically control the machines from a remote computer.

### SUMMARY OF THE INVENTION

According to one aspect of the present invention, a device for automating and/or controlling machine tools, production machines and/or robots includes at least one computer located remotely from a machine. The remote computer is connected via at least one bus system with each machine for unidirectional or bidirectional exchange of data and control signals. All control functions of the machine are integrated in the at least one remote computer.

According to one advantageous feature of the invention, the bus system can be implemented as an Ethernet bus. An Ethernet bus is renowned for having a particularly high data throughput rate.

According to another advantageous embodiment of the invention, the bus system can be implemented redundantly by using several buses. This ensures a particularly high availability of the device.

According to yet another advantageous feature of the invention, the computer can be a personal computer or a workstation. Using personal computers and/or workstations makes the entire system very cost-effective.

Advantageously, the control functions of several machines can be processed in parallel on a single computer. By using only one computer for controlling several machines, the device can be implemented very cost-effectively.

According to another advantageous feature of the invention, the control functions can be divided among and processed on several computers. If the control functions for a large number of machines are executed centrally, then it may become necessary if a computer is overtaxed by performing this task, to distribute the many control functions over several computers which then process these control functions in parallel.

According to another advantageous feature of the invention, the machines can be provided with an UltraThinClient without an inherent intelligence. If the machine is to be operated in situ, then it is advantageous to employ an UltraThinClient without inherent intelligence which converts the operator input into bus telegrams and receives the incoming telegrams with the display information (e.g., the pixel data for a monitor).

According to still another advantageous feature of the invention, a central electric power supply can be provided for supplying electric power to the machines. According to the invention, the conventional dedicated power supplies of several machines are combined into one central electric power supply, which also reduces cost.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a block the diagram of the device according to the present invention; and

FIG. 2 shows the software architecture of the computer.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

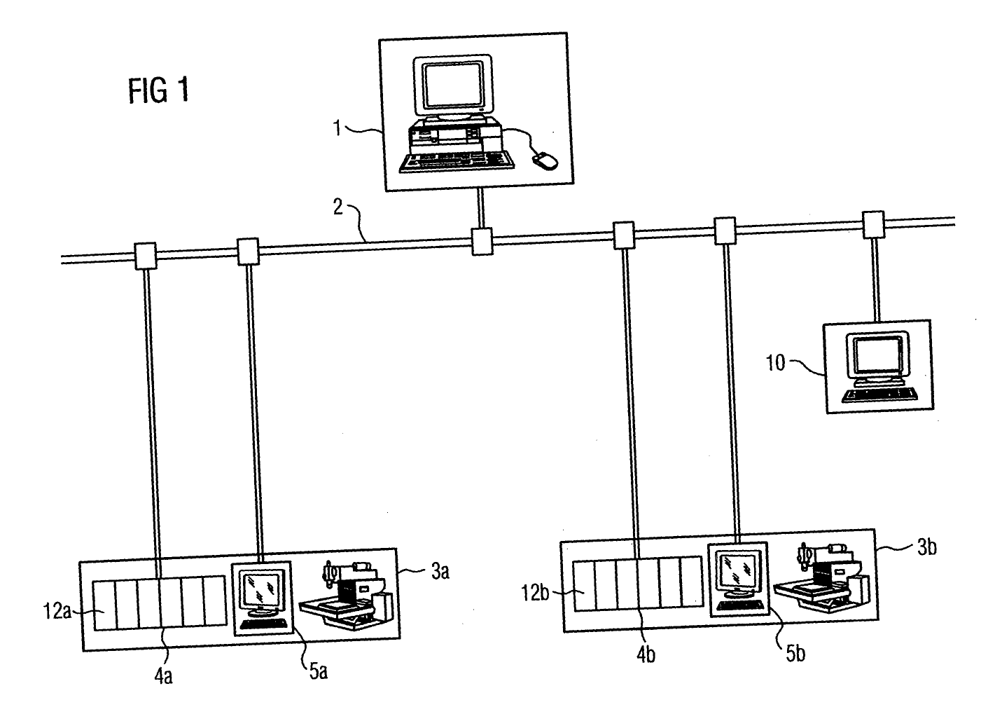

Turning now to the drawing, and in particular to FIG. 1, there is shown a block diagram of a computer 1 which is located remote from machines 3a and 3b and connected via a bus system 2 with the machine 3a and the machine 3b. The machines 3a and 3b can be, for example, machine tools, processing machines and/or robots. The bus system 2 supports a unidirectional or bidirectional exchange of data and control information between the computer 1 and the machines 3a and 3b. An I/O unit (input/output unit) 4a, which can include several I/O units, can be integrated in the machine 3a. For sake of clarity, only one I/O module 12a is indicated and only one UltraThinClient 5a is integrated. The I/O modules 12a are associated with the sensors and actuators of the machine 3a in one-to-one correspondence. Sensors refer hereby to, for example, rotation encoders, linear encoders, acceleration sensors, switches, contacts and measurement systems in general. Actuators refer to, for example, the driven section of the machine. Integrated in the machine 3b are, for example, a corresponding I/O unit 4b, which can include several I/O modules, of which for sake of clarity only one I/O module 12b is labeled, and a corresponding UltraThinClient 5b. The machines 3a and 3b can also include other components which are less important for an understanding of the invention and are therefore not shown in FIG. 1.

The entire intelligence of the illustrated arrangement, including, for example, the control software for the axial motion of the machines, is included in the computer 1. The computer 1 is connected via the bus system 2 and the I/O units 4a and 4b with the sensors and actuators of the machine 3a and 3b, respectively. A sensor signal of, for example, the machine 3a is transmitted to the computer almost instantaneously provided the bus system 2 has a sufficiently high data throughput rate. The sensor signal is then further processed by the control functions of the computer 1. Optionally, a corresponding control signal can be transmitted from the computer 1 via the bus system 2 and the I/O units 4a and 4b to the actuators of the machines 3a and 3b, respectively.

As mentioned above, the bus system 2 should have a sufficiently high data throughput rate. In practical applications, only the Ethernet bus system has met these requirements. The data throughput rate can be increase even further by using two buses instead of a single bus. In this case, one bus could be dedicated to the sensors and actuators of the machine, for which real-time operation is indicated, and a second bus could be dedicated to operations requiring transmission of a large number of data. Since the bus system 2 in the device of the invention is an essential component for controlling the machines, it has to have a higher availability and should therefore be implemented redundantly.

For optional in situ operation, so-called UltraThinClients 5a and 5b can be employed which do not have any inherent intelligence. The UltraThinClients 5a and 5b only need to convert the operator input to bus telegrams and receive the incoming telegrams, such as display information (e.g., the pixel data for the monitor). By optionally using an existing terminal 10 which can be located remote from the machines 3a and 3b and the computer 1 and which can also be implemented in the form of an UltraThinClient 5a or 5b, process data can be visualized and changed, and data and programs in the computer 1 can be accessed.

The block diagram of FIG. 1 depicts two exemplary machines 3a and 3b and a computer 1. However, other embodiments with an arbitrary number of machines are feasible. If the processing power of an individual computer is not adequate, then several computers can be connected to the bus system 2 for controlling the machines, with the control functions being processed in parallel.

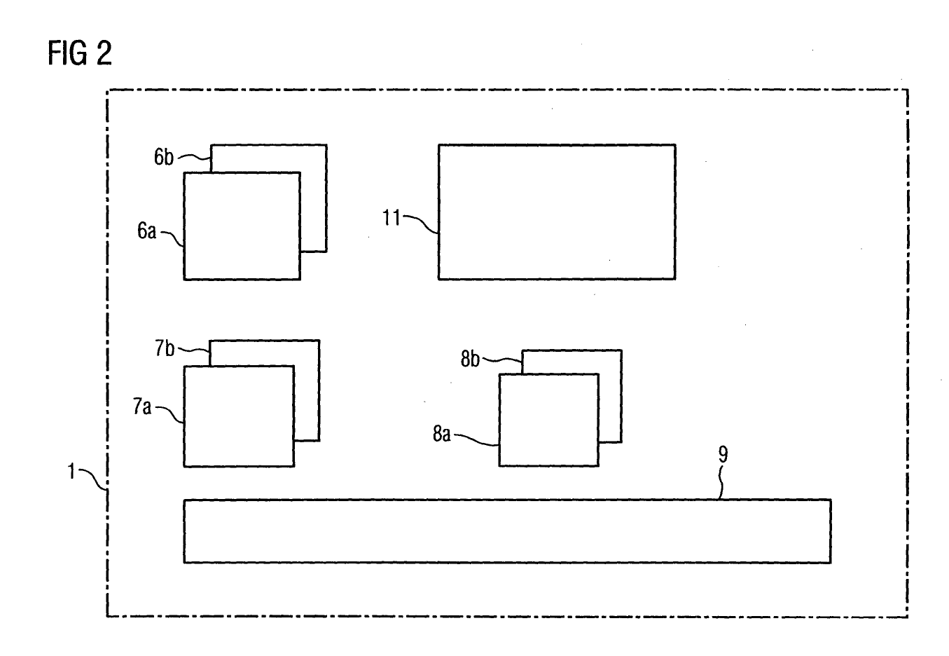

The block diagram of FIG. 2 depicts the software structure of the computer 1. FIG. 2 depicts an exemplary embodiment with two machines 3a and 3b and a computer 1 as described previously with reference to FIG. 1. The computer is under the control of an operating system 9. For each machine 3a and 3b there exists in software an HMI (Human Machine Interface) server associated with the corresponding machine, as well as a functional control program 7a and 7b and a workpiece program 8a and 8b, respectively. In the embodiment depicted in FIG. 2, the HMI server 6a, the functional control program 7a and the workpiece program 8a are associated with the machine 3a. The HMI server 6b, the functional control program 7b and the workpiece program 8b are associated with the machine 3b. A process control program 11 controls a master process between the machines 3a and 3b. The HMI server 6a or 6b administers and controls the UltraThinClient 5a or 5b which is associated with the particular server on the machine 3a or 3b, as depicted in FIG. 1. The functional control programs 7a and 7b, respectively, execute separately for each machine to control, for example, axial movements of the machine 3a and/or 3b which are under the control of the NC/PLC (Numerical Control/Programmable Logic Control).

A workpiece program with associated data, such as tool correction data, tool geometry, etc. is associated with each machine 3a and 3b. For example, the workpiece program 8a is associated with the machine 3a, and the workpiece program 8b is associated with the machine 3b. The workpiece program 8a, for example, computes as output values the nominal axes positions of the machine axes, and supplies the computed values to the input by the functional control program 7a. The workpiece program 8b and the functional control program 7b cooperate in a similar manner.

The computer 1 can be implemented as a conventional personal computer which have attained a high computing power. If desired, a workstation with a higher computing power can be used.

By shifting the automation tasks from individual machines to a central control and automation device with decentralized I/O units, a much lesser degree of automation is required within a machine. For example, control cabinets typically installed in the immediate vicinity of the machines can be replaced by smaller cabinets or eliminated entirely, since the drive components of the machine can be decentralized and incorporated in the automation and control device, whereas the electric power supply modules required for the drive components of several machines can be combined into a central electric power supply device. Instead of supplying the machines with three-phase AC current, a so-called intermediate circuit voltage (typically 600V DC) which is typically generated in each machine from the AC supply current for supplying power to the drive components, is directly routed to the machines from the central power supply device. In addition, the energy which is typically released, for example, when braking a machine spindle, can be used directly via an electric converter for operating the other machines.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A device for controlling a plurality of machines, comprising at least one computer located remote from at least one of the machines, said at least one remote computer connected via at least one bus system with each of the machines for unidirectional or bidirectional exchange of data and control signals between the at least one-computer and the machines, wherein all functions for controlling the machines are integrated in the at least one remote computer.

2. The device of claim 1, wherein the at least one bus system comprises an Ethernet bus system.

3. The device of claim 1, wherein the at least one bus system is a redundant bus system.

4. The device of claim 1, wherein the at least one computer is a personal computer or a workstation.

5. The device of claim 1, wherein the control functions for at least two machines are executed in parallel on the remote computer.

6. The device of claim 1, wherein the control functions are distributed over at least two remote computers for processing.

7. The device of claim 1, wherein the machine is provided with an UltraThinClient that lacks a built-in intelligence.

8. The device of claim 1, and further comprising a central electric power supply for supplying electric power to the machines.

9. The device of claim 1, wherein the machines are selected from the group consisting of machine tools, processing machines and robots.
